(19) United States
(12) Patent Application Publication
(10) Pub. No.: US 2007/0200903 A1
(43) Pub. Date: Aug. 30, 2007

(54) DROPLET JETTING APPLICATOR AND METHOD FOR MANUFACTURING COATED BODY

(75) Inventors: Hironori Takabayashi, Yokohama-shi (JP); Naoaki Sakurai, Yokohama-shi (JP); Atsushi Kinase, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/535,304

(22) Filed: Sep. 26, 2006

(30) Foreign Application Priority Data
Feb. 28, 2006 (JP) 2006-053923

(51) Int. Cl. B41J 2/17

(52) U.S. Cl. 347/84

(57) ABSTRACT

A droplet jetting applicator includes a droplet jetting head having an inside channel allowing a passage of the liquid supplied from a liquid accommodating part to jet the liquid flowing in the inside channel in form of droplets, a liquid supply channel communicating the liquid accommodating part with the inside channel of the droplet jetting head, a liquid supply part supplying the liquid from the liquid accommodating part to the droplet jetting head through the liquid supply channel, a liquid return channel communicating the inside channel of the droplet jetting head with the liquid accommodating part and a liquid return part interposed in the liquid return channel to return the liquid after passing through the inside channel of the droplet jetting head from the droplet jetting head to the liquid accommodating part through the liquid return channel.

### CROSS REFERENCE OF THE RELATED APPLICATION

This application is based on and claims the benefit of priority from the prior Japanese Patent Application No. 2006-53923, filed on Feb. 28, 2006; the entire content of which are incorporated herein by reference.

### BACKGROUND OF THE INVENTION

1. Field of the Invention

The present invention relates to a droplet jetting applicator for jetting droplets and a method for manufacturing a coated body with the use of the droplet jetting applicator.

2. Discussion of the Background

Generally, a droplet jetting applicator is utilized to manufacture a liquid crystal display unit, an organic EL (Electro Luminescence) unit, an electron emission unit, a plasma display unit, an electrophoretic display unit and so on.

This droplet jetting applicator is equipped with droplet jetting heads (e.g. ink-jet heads) for jetting liquid in the form of droplets through a plurality of nozzles. By the droplet jetting heads, droplets are landed on an object to be coated, so that a designated pattern of dot rows are formed to produce a coated body, for instance, color filter, black matrix (i.e. a frame of color filter) and so on (e.g. see JP-A No. 2005-262464(KOKAI)). Note that a wide variety of inks (e.g. aqueous ink, oil ink, ultraviolet curing ink) are used as the liquid. For instance, the oil ink is composed of various ink components (e.g. pigment, solvent, dispersing agent, additives, interfacial active agent, etc.).

However, the above-mentioned droplet jetting applicator has problems with ink components deposited and bubbles produced in the ink. Such a phenomenon has a damaging effect on the jetting capability of the droplet jetting heads.

For instance, if the deposition of ink components occurs, then both surface tension of the ink and its degree of viscosity change and therefore, an optimum jetting condition (e.g. driving voltage for heads, pulse width, etc.) changes. In this case, unless the jetting condition for the droplet jetting heads is set up again, defective jet would occur in the droplet jetting heads, causing lopsided or thin spotting. Especially, if the degree of ink deposition is severe, the nozzles may be clogged with ink, causing non-jet of droplets.

Similarly, when dissolved gas in the ink causes bubbles to be produced in the ink, there is a possibility that the nozzles are clogged with the bubbles. Also in this case, defective jet occurs in the droplet jetting heads, causing lopsided or thin spotting. Especially, if a great number of bubbles are present in the ink, then the nozzles are clogged with the bubbles in large quantity, causing non-jet of droplets.

### SUMMARY OF THE INVENTION

In the above-mentioned situation, it is an object of the present invention to provide a droplet jetting applicator and a method for manufacturing a coated body, all of which can prevent an occurrence of defective jet due to deposition of liquid components and bubbles in liquid.

In order to attain the above object, according to a first aspect of embodiments of the present invention, there is provided a droplet jetting applicator, which includes a liquid accommodating part accommodating liquid; a droplet jetting head having an inside channel allowing a passage of the liquid supplied from the liquid accommodating part, the droplet jetting head jetting the liquid flowing in the inside channel in form of droplets; a liquid supply channel communicating the liquid accommodating part with the inside channel of the droplet jetting head, supplying the liquid from the liquid accommodating part to the droplet jetting head; a liquid supply part interposed in the liquid supply channel to supply the liquid from the liquid accommodating part to the droplet jetting head through the liquid supply channel; a liquid return channel communicating the inside channel of the droplet jetting head with the liquid accommodating part, returning the liquid after passing through the inside channel of the droplet jetting head from the droplet jetting head to the liquid accommodating part; and a liquid return part interposed in the liquid return channel to return the liquid after passing through the inside channel of the droplet jetting head from the droplet jetting head to the liquid accommodating part through the liquid return channel.

According to a second aspect of embodiments of the present invention, there is also provided a method for manufacturing a coated body, which includes jetting a droplet to an object to be coated with use of a droplet jetting applicator of the first aspect.

### BRIEF DESCRIPTION OF THE DRAWINGS

FIG. 1 is a perspective view showing a schematic structure of a droplet jetting applicator in accordance with one embodiment of the present invention;

FIG. 2 is a pattern diagram showing the schematic structure of the droplet jetting applicator of FIG. 1;

FIG. 3 is a pattern diagram showing a part of the droplet jetting applicator of FIG. 2 in enlargement; and

FIG. 4 is a flow chart showing a flow of a liquid circulating process of the droplet jetting applicator of FIGS. 1 and 2.

### DETAILED DESCRIPTION OF THE INVENTION

An embodiment of the present invention will be described with reference to drawings.

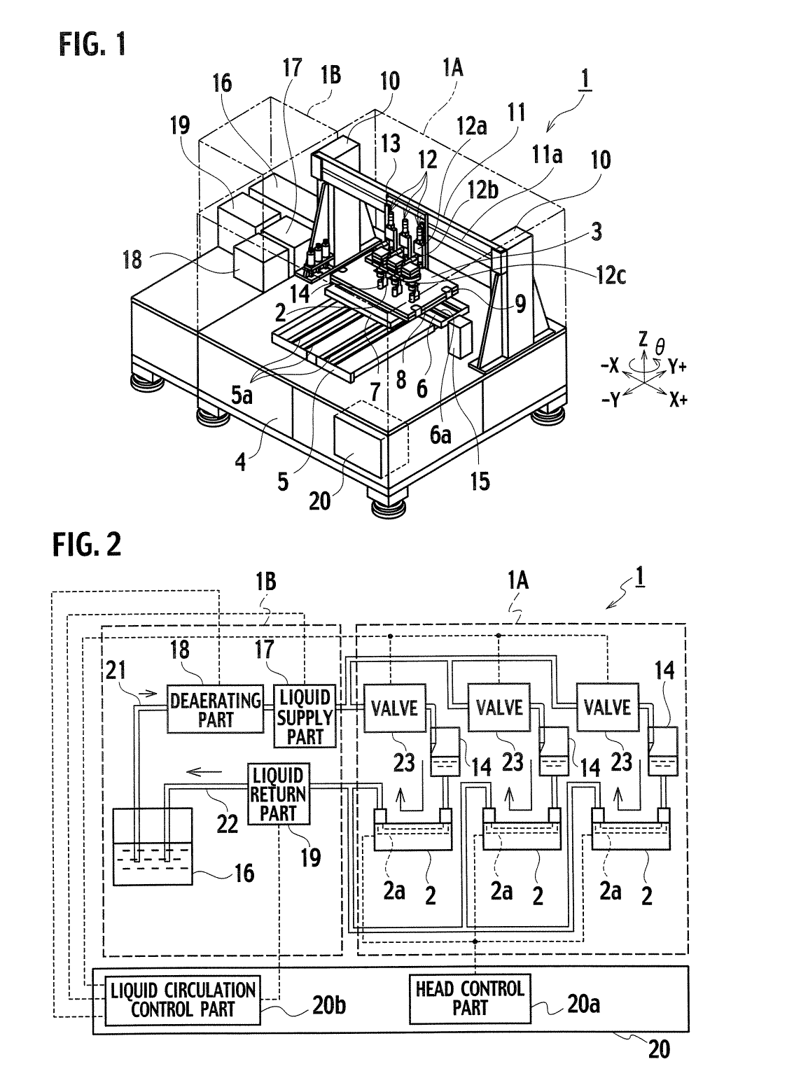

As shown in FIG. 1, a droplet jetting applicator 1 comprises an ink applicator box 1A for applying ink on a substrate 3 with the use of droplet jetting heads 2 jetting ink (liquid) in the form of droplets through nozzles and an ink supply box 1B for supplying the ink applicator box 1A with ink. The ink applicator box 1A and the ink supply box 1B are situated next to each other and together fixed on a top surface of a frame 4.

In the ink applicator box 1A, there are successively stacked a Y-axis direction slide plate 5, a Y-axis direction moving table 6, an X-axis direction slide plate 7 and an X-axis direction moving table 8. The Y-axis direction slide plate 5, the Y-axis direction moving table 6, the X-axis direction slide plate 7 and the X-axis direction moving table 8 are formed to be flat plates respectively.

The Y-axis direction slide plate 5 is fixed on the top surface of the frame 4. The Y-axis direction slide plate 5 is provided, on its top surface, with a plurality of guide grooves 5a along a direction of Y-axis. Engaged in the guide grooves 5a are guide projections (not shown) which are formed on a lower surface of the Y-axis direction moving table 6. Consequently, the Y-axis direction moving table 6 is arranged on the top surface of the Y-axis direction slide plate 5 so as to be movable along the direction of Y-axis. The Y-axis direction moving table 6 is moved in the direction of Y-axis along the guide grooves 5a by a drive mechanism using a Y-axis direction moving motor.

The Y-axis direction moving table 6 is provided, on its top surface, with a plurality of guide grooves 6a along a direction of X-axis. Engaged in the guide grooves 6a are guide projections (not shown) which are formed on a lower surface of the X-axis direction moving table 7. Consequently, the X-axis direction moving table 7 is arranged on the top surface of the Y-axis direction moving table 6 so as to be movable along the direction of X-axis. The X-axis direction moving table 7 is moved in the direction of Y-axis along the guide grooves 6a by a drive mechanism using an X-axis direction moving motor (not shown).

A substrate carrier table 8 for holding the substrate 3 is fixed on a top surface of the X-axis direction moving table 7. The substrate carrier table 8 is provided with a substrate gripping mechanism 9 for gripping the substrate 3. Thus, the substrate 3 is tightly fixed on the substrate carrier table 8 by the substrate gripping mechanism 9. The substrate gripping mechanism 9 is formed by, for instance, U-shaped nipping tools. Note that as holding means for holding the substrate 3, a substrate absorbing mechanism for absorbing the substrate 3 may be provided in place of the substrate gripping mechanism 9. For example, rubber suction cups, a suction pump or the like may be adopted for the substrate gripping mechanism 9.

Here, a moving distance of the substrate carrier table 8 in the direction of Y-axis is detected on the basis of pulse signals (position signals) outputted from a Y-axis direction encoder (not shown), while a moving distance of the substrate carrier table 8 in the direction of X-axis is detected on the basis of pulse signals outputted from an X-axis direction encoder (not shown).

In the ink applicator box 1A, a pair of columns (supporting braces) 10 are arranged to stand upright. These columns 10 are arranged so as to interpose the Y-axis direction slide plate 5 in a perpendicular direction to the guide grooves 5a, that is, in the direction of X-axis.

An X-axis slide plate 11 is arranged to lie across these columns 10 laterally. The X-axis slide plate 11 is provided, on its front surface, with a guide groove 11a extending in the direction of X-axis. A plurality of ink-jet head units 12 are arranged so as to hang from a base plate 13. The base plate 13 is provided, on its rear surface, with a guide projection (not shown) that engages with the guide groove 11a of the X-axis slide plate 11. Thus, the base plate 13 is arranged on the X-axis slide plate 11 so as to be movable in the direction of X-axis. The base plate 13 (i.e. the ink-jet head units 12) is moved in the direction of X-axis along the guide groove 11a by a drive mechanism using a head-unit moving motor (not shown).

The ink-jet head units 12 are equipped with the droplet jetting heads 2, respectively. These droplet jetting heads 2 are detachably fitted to the leading ends of the ink-jet head units 12, respectively. Each of the droplet jetting heads 2 includes a nozzle plate (not shown) having a plurality of nozzles (through-holes) for jetting droplets. The droplet jetting head 2 is provided with a liquid (ink) buffer tank 14 for storing ink. Note that the liquid buffer tank 14 is formed integrally with the droplet jetting head 2. Thus, the liquid buffer tank 14 can be attached to and detached from the ink-jet head unit 12, together the droplet jetting head 2.

Each ink-jet head unit 12 is provided with a Z-axis direction moving mechanism 12a for moving the corresponding droplet jetting head 2 vertically to a surface (upper surface) of the substrate 3, that is, in the direction of Z-axis, a Y-axis direction moving mechanism 12b for moving the corresponding droplet jetting head 2 in the direction of Y-axis and a θ direction rotating mechanism 12c for rotating the corresponding droplet jetting head 2 in the direction of θ. In this way, the droplet jetting heads 2 can move in the directions of Z-axis and Y-axis and also rotate in the direction of θ.

In the ink applicator box 1A, a head maintenance unit 15 is arranged to clean up respective nozzles of the droplet jetting heads 2, which are clogged with inks. The head maintenance unit 15 is positioned on an extension line of the moving direction of the ink-jet head units 12, apart from the substrate 3. In operation, when a certain ink-jet head unit 12 moves to a standby position opposing the head maintenance unit 15, it begins to clean up a clogged nozzle in the relevant ink-jet head unit 12 automatically.

In the ink supply box 1B, there are a liquid accommodating part 16, such as ink tank for accommodating ink, a liquid supply part 17 that supplies ink from the liquid accommodating part 16 to the respective droplet jetting heads 2 through the liquid buffer tanks 14, a deaerating part 18 that removes dissolved gas, which is likely to be a source of bubbles, from the ink supplied to the droplet jetting heads 2 and a liquid return part 19 that returns the ink from the droplet jetting heads 2 to the liquid accommodating part 16.

Note that the liquid buffer tanks 14 are supplied with the ink from the liquid accommodating part 16 through the liquid supply part 17. As for the ink, there are a variety of inks available, such as aqueous ink, oil ink and ultraviolet curing ink. For instance, the oil ink is composed of various components (e.g. pigment, solvent, dispersing agent, additives, interfacial active agent, etc.).

In the frame 4, there are a control part 20 for controlling respective parts of the droplet jetting applicator 1 and a memory part (not shown) for storing a variety of programs. Based on the programs stored in the memory part, the control part 21 performs various controls: moving control of the Y-axis direction moving table 6; moving control of the X-axis direction moving table 7, moving control of the base plate 13; drive control of the Z-axis direction moving mechanism 12a; drive control of the Y-axis direction moving mechanism 12b; drive control of the Θ direction rotating mechanism 12c, etc. Consequently, it is possible to change a position of the substrate 3 carried on the substrate carrier table 8 in relation to the droplet jetting heads 2 of the ink-jet head units 12, variously.

Next, we describe respective parts of the droplet jetting applicator 1 related to circulation of ink.

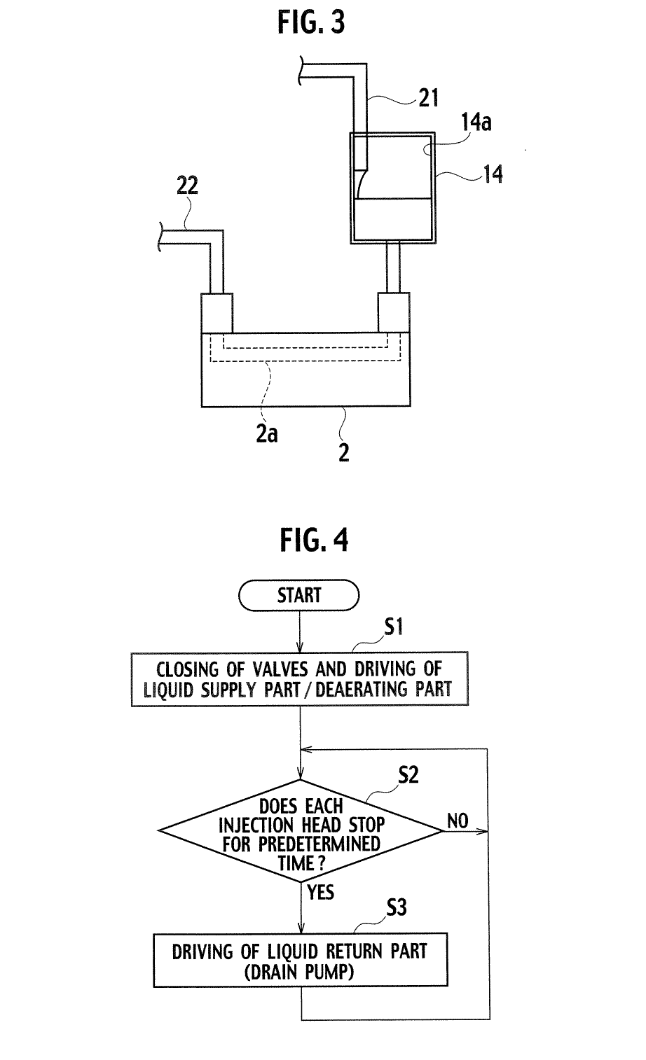

As shown in FIG. 2, each droplet jetting head 2 includes an inside channel 2a through which the ink supplied from the liquid accommodating part 16 passes (see FIG. 3) and jets the ink passing through the inside channel 2a, in the form of droplets. Note that the control part 20 comprises a head control part 20a for controlling the operations of the droplet jetting heads 2 and a liquid circulation control part 20b for controlling the operations of the liquid supply part 17, the deaerating part 18, the liquid return part 19 and a plurality of valves 23.

Between the liquid accommodating part 16 and the droplet jetting heads 2, a liquid supply channel 21 is provided to communicate the liquid accommodating part 16 with the inside channels 2a of the droplet jetting heads 2. This liquid supply channel 21 is identical to a flow channel for supplying ink from the liquid accommodating part 16 to the respective droplet jetting heads 2. For example, a tube is available for the liquid supply channel 21.

Between the droplet jetting heads 2 and the liquid accommodating part 16, a liquid return channel 22 is provided to communicate the inside channels 2a of the droplet jetting heads 2 with the liquid accommodating part 16. This liquid return channel 22 is identical to a flow channel for returning ink after passing through the inside channels 2a from the droplet jetting heads 2 to the liquid accommodating part 16. For example, a tube is available for the liquid return channel 22.

In the liquid supply channel 21, there are arranged the deaerating part 18, the liquid supply part 17, the valves 23 and the liquid buffer tanks 14, in order from the liquid accommodating part 16. Additionally, a liquid return part 19 is interposed in the liquid return channel 22.

The deaerating part 18 is formed by a unit for removing dissolved gas from the ink flowing in the liquid supply channel 21. Further, the valves 23 are arranged so as to correspond to the droplet jetting heads 2, respectively. In operation, these valves 23 are opened normally. When exchanging a certain droplet jetting head 2, the corresponding valve 23 is closed.

The liquid supply part 17 is identical to a unit for supplying ink from the liquid accommodating part 16 to the droplet jetting heads 2 through the liquid supply channel 21. For instance, this liquid supply part 17 is formed by a fluid pump or the like.

The liquid return part 19 is a unit that urges liquid in the flow channel in order to return the ink on passage of the inside channels 2a of the droplet jetting heads 2 to the liquid accommodating part 16 through the liquid return channel 22. For instance, this liquid return part 19 is also formed by a fluid pump or the like.

Each of the liquid buffer tanks 14 is provided to adjust an ink level (meniscus) at a tip of the nozzle through the use of a water-head difference (water-head pressure) between a level of ink stored in the liquid buffer tank 14 and a nozzle surface (i.e. an outer surface of the nozzle plate) of the relevant droplet jetting head 2. Owing to the provision of these buffer tanks 14, consequently, it is possible to prevent both leakage of ink and its undesirable jet.

Additionally, the liquid buffer tanks 14 function as bubble removing part for removing bubbles from the ink flowing in the liquid supply channel 21. As shown in FIG. 3, each of the liquid buffer tanks 14 allows the ink to flow along an inner wall surface 14a and further stores the ink flowing along the surface 14a. In this process, bubbles existing in the liquid supply channel 21 are eliminated. Additionally, it is also possible to remove bubbles entering the liquid supply channel 21 due to an exchanging operation of the droplet jetting head 2 etc.

Next, we describe a droplet jetting operation and a liquid circulating operation by the above-constructed droplet jetting applicator 1. The control part 20 of the droplet jetting applicator 1 executes the droplet jetting operation and the liquid circulating operation, based on a variety of programs.

In the droplet jetting operation of the droplet jetting applicator 1, the control part 20 allows the ink-jet head units 12 to move from the standby positions to respective positions opposing the substrate 3. Consequently, the ink-jet head units 12 move to the positions opposing the substrate 3 while being guided by the guide groove 11a of the X-axis direction slide plate 11. Next, the control part 20 controls the driving of the Y-axis direction moving table 6 and the X-axis direction moving table 7, while the head control part 20a of the control part 20 controls the jetting operation of the droplet jetting heads 2 of the ink-jet head units 12. Correspondingly, the droplet jetting heads 2 discharge the ink in the inside channels 2a from the nozzles, in the form of droplets. Then, the droplets land in the substrate 3 moving in the direction of Y-axis, successively forming a designated pattern of dot rows.

FIG. 4 is a flow chart showing a flow of a liquid circulating process by the droplet jetting applicator 1.

In the liquid circulating process, as shown in FIG. 4, the liquid circulation control part 20b of the control part 20 normally maintains the valves 23 in their closed state and drives the liquid supply part 17 and the deaerating part 18 while the droplet jetting applicator 1 is powered on (step S1). Consequently, the ink in the liquid accommodating part 16 passes through the deaerating part 18 via the liquid supply channel 21. Then, dissolved gas is removed from the ink flowing in the liquid supply channel 21 by the deaerating part 18. The ink after removing the dissolved gas is stored in the liquid buffer tanks 14 through the liquid supply channel 21. Then, the bubbles existing in the liquid supply channel 21 are removed by the liquid buffer tanks 14. Subsequently, the ink in the liquid buffer tank 14 is supplied into the inside channel 2a of the relevant droplet jetting head 2, corresponding to its jetting operation. The ink supplied into the inside channel 2a is discharged from the nozzle of the droplet jetting head 2 due to the above-mentioned droplet jetting process.

Next, at step S2, the liquid circulation control part 20b judges whether the jet of each droplet jetting head 2 comes to a standstill for a predetermined time (e.g. approx. 3 minutes) or not. If the judgment at step S2 is No, then it is executed to hold a process up as far as an expiry of the predetermined time. For example, the liquid circulation control part 20b judges whether the jet of the droplet jetting head 2 is in a rest condition or not (e.g. during transporting of the substrate 3, during changing of set-up).

If it is judged that the jetting of the droplet jetting head 2 comes to a standstill for the predetermined time (Yes at step S2), then the routine goes to step S3 to drive the liquid return part 19. Thereafter, the routine returns to step S2. As a result, the ink in the inside channels 2a of the respective droplet jetting heads 2 returns to the liquid accommodating part 16 through the liquid return channel 22. In this way, the ink in the liquid accommodating part 16 circulates in the liquid supply channel 21, the inside channels 2a of the droplet jetting heads 2 and the liquid return channel 22, in order.

As mentioned above, according to the embodiment of the present invention, owing to the provision of the liquid return channel 22 and the liquid return part 19, it is accomplished that the ink in the inside channels 2a of the droplet jetting heads 2 returns to the liquid accommodating part 16 through the liquid return channel 22, while the ink in the liquid accommodating part 16 circulates in the inside channels 2a of the droplet jetting heads 2 and the liquid return channel 22. Therefore, it is possible to prevent ink components from being deposited. Additionally, as the provision of the deaerating part 18 in the liquid supply channel 21 allows the dissolved gas to be removed from the ink flowing in the liquid supply channel 21, it is possible to prevent an occurrence of bubbles in the liquid supply channel 21. From these reasons, it is possible to prevent jet-defectiveness from being caused by the deposition of ink components and the bubbles in the ink.

Additionally, since there are provided, as a bubble removing part that removes bubbles from the ink flowing in the liquid supply channel 21, the liquid buffer tanks 14 in the liquid supply channel 21, it is possible to prevent jet-defectiveness from being caused by the bubbles in the ink more certainly. Particularly, it is possible to eliminate bubbles entering the liquid supply channel 21 at the exchange of the droplet jetting heads 2.

Further, since the liquid buffer tanks 14 allow the ink flowing in the liquid supply channel 21 to flow along the inner wall surfaces 14a and store the ink, it is possible to certainly eliminate the bubbles from the ink flowing in the liquid supply channel 21 with its simple structure. Additionally, the levels of ink in the nozzle can be adjusted easily by changing a quantity of ink stored in each liquid buffer tank 14.

Still further, as coated bodies, such as color filter and black matrix (i.e. a frame of the cooler filter), can be manufactured by the above-mentioned droplet jetting applicator 1 that jets droplets against the substrate 3 as an object to be coated with liquid, it is possible to prevent an occurrence of defective coated bodies, producing coated bodies of higher reliability.

### Other Embodiment

Note that the present invention is not limited to the above-mentioned embodiments and the invention may be modified variously within a scope of the essence of the present invention.

For example, although the liquid buffer tanks 14 are interposed in the liquid supply channel 21 in the above-mentioned embodiment, the invention is not limited to this arrangement. In this view, the liquid supply channel 21 may be provided with no buffer tank in the modification.

What is claimed is:

1. A droplet jetting applicator comprising:
a liquid accommodating part accommodating liquid;
a droplet jetting head having an inside channel allowing a passage of the liquid supplied from the liquid accommodating part, the droplet jetting head jetting the liquid flowing in the inside channel in form of droplets;
a liquid supply channel communicating the liquid accommodating part with the inside channel of the droplet jetting head, supplying the liquid from the liquid accommodating part to the droplet jetting head;
a liquid supply part interposed in the liquid supply channel to supply the liquid from the liquid accommodating part to the droplet jetting head through the liquid supply channel;
a liquid return channel communicating the inside channel of the droplet jetting head with the liquid accommodating part, returning the liquid after passing through the inside channel of the droplet jetting head from the droplet jetting head to the liquid accommodating part; and
a liquid return part interposed in the liquid return channel to return the liquid after passing through the inside channel of the droplet jetting head from the droplet jetting head to the liquid accommodating part through the liquid return channel.

2. The droplet jetting applicator according to claim 1, further comprising:
a deaerating part interposed in the liquid supply channel to remove dissolved gas from the liquid flowing in the liquid supply channel.

3. The droplet jetting applicator according to claim 1, further comprising:
a bubble removing part interposed in the liquid supply channel to remove bubbles from the liquid flowing in the liquid supply channel.

4. The droplet jetting applicator according to claim 3, wherein:
the bubble removing part is formed so as to allow the liquid flowing in the liquid supply channel to flow along an inner wall of the bubble removing part and store the liquid after flowing along the inner wall.

5. A method for manufacturing a coated body, comprising:
preparing a droplet jetting applicator; and
jetting a droplet to an object to be coated with use of the droplet jetting applicator, wherein:
the droplet jetting applicator includes:
a liquid accommodating part accommodating liquid;
a droplet jetting head having an inside channel allowing a passage of the liquid supplied from the liquid accommodating part, the droplet jetting head jetting the liquid flowing in the inside channel in form of droplets;
a liquid supply channel communicating the liquid accommodating part with the inside channel of the droplet jetting head, supplying the liquid from the liquid accommodating part to the droplet jetting head;
a liquid supply part interposed in the liquid supply channel to supply the liquid from the liquid accommodating part to the droplet jetting head through the liquid supply channel;
a liquid return channel communicating the inside channel of the droplet jetting head with the liquid accommodating part, returning the liquid after passing through the inside channel of the droplet jetting head from the droplet jetting head to the liquid accommodating part; and
a liquid return part interposed in the liquid return channel to return the liquid after passing through the inside channel of the droplet jetting head from the droplet jetting head to the liquid accommodating part through the liquid return channel.

6. The method for manufacturing a coated body according to claim 5, wherein the droplet jetting applicator further includes:
a deaerating part interposed in the liquid supply channel to remove dissolved gas from the liquid flowing in the liquid supply channel.

7. The method for manufacturing a coated body according to claim 5, wherein the droplet jetting applicator further includes:
a bubble removing part interposed in the liquid supply channel to remove bubbles from the liquid flowing in the liquid supply channel.

8. The method for manufacturing a coated body according to claim 7, wherein:
the bubble removing part is formed so as to allow the liquid flowing in the liquid supply channel to flow along an inner wall of the bubble removing part and store the liquid after flowing along the inner wall.
